(19) United States
(12) Patent Application Publication
(10) Pub. No.: US 2009/0160762 A1
(43) Pub. Date: Jun. 25, 2009

(54) User input device with expanded functionality

(75) Inventor: Jesse L. Dorogusker, Los Altos, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/004,544

(22) Filed: Dec. 20, 2007

(51) Int. Cl. G09G 5/00

(52) U.S. Cl. 345/156

(57) ABSTRACT

The present invention can include systems and methods for expanding the functionality of user input devices. In particular, the present invention can expand the functionality of user input devices by changing the functions assigned to hardwired user input mechanisms responsive to user actuation of a function-change user input mechanism and/or responsive to automatic detection of an application change. Each hardwired user input mechanism can have an associated function indicator that visually indicates the function assigned to the hardwired user input mechanism. The present invention also can change the function indicated by the function indicators when there is a change in the functions assigned to the hardwired user input mechanisms.

### FIELD OF THE INVENTION

The present invention relates to systems and methods for expanding the functionality of a user input device.

### BACKGROUND OF THE INVENTION

Some currently available user input devices have a limited number of hardwired buttons. For some applications, there may be a need for more buttons to provide additional control. However, adding more buttons to a product may not be desirable because it can make the device larger, less attractive, more cluttered, and, ultimately, more complicated to use.

Some products have attempted to solve this problem by integrating touchscreen user interfaces having multiple soft-coded user inputs. Unfortunately, while this does permit additional functionality to be added to the device, it does so at much higher cost. Such designs also may lack the usability of hardwired buttons, which are dedicated for specific functions.

### SUMMARY OF THE INVENTION

The present invention can include systems and methods for expanding the functionality of user input devices. In particular, the present invention can expand the functionality of user input devices by changing the functions assigned to hardwired user input mechanisms. The device can change the function assigned to a hardwired user input mechanism responsive to user actuation of a function-change user input mechanism and/or responsive to automatic detection of an application change. Embodiments of the function-change user input mechanism also are provided.

Each hardwired user input mechanism can have an associated function indicator that visually indicates the function assigned to the hardwired user input mechanism. The present invention also can change the function indicated by the function indicators when there is a change in the functions assigned to the hardwired user input mechanisms. Embodiments of the function indicators also are provided.

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIGS. 1A-1B show an illustrative user input device in accordance with one embodiment of the present invention;

FIG. 2A is an illustrative block diagram of the user input device of FIG. 1 in accordance with one embodiment of the present invention;

FIG. 2B is an illustrative block diagram of a remote host device configured to interact with the user input device of FIGS. 1A-2 in accordance with one embodiment of the present invention;

FIGS. 3A-3B show a first illustrative function indicator in accordance with one embodiment of the present invention;

FIGS. 4A-4B show a second illustrative function indicator in accordance with one embodiment of the present invention;

FIGS. 5A-5B show a third illustrative function indicator in accordance with one embodiment of the present invention;

FIGS. 6A-6B show a fourth illustrative function indicator in accordance with one embodiment of the present invention;

FIGS. 7A-7B show another illustrative user input device in accordance with one embodiment of the present invention;

FIGS. 8A-8B is an illustrative flowchart of a user-initiated process for changing the functions assigned to hardwired user input mechanisms in accordance with one embodiment of the present invention; and

FIGS. 9A-9B is an illustrative flowchart of an automatic process for changing the functions assigned to hardwired user input mechanisms in accordance with one embodiment of the present invention.

### DETAILED DESCRIPTION OF THE INVENTION

Some currently available user input devices have a limited number of hardwired buttons. For some applications, there may be a need for more buttons to provide additional control. Some products have attempted to solve this problem by integrating touchscreen user interfaces having multiple soft-coded user input. Unfortunately, while this does permit additional functionality to be added to the device, it does so at much higher cost and increased device size. It also may lack the usability of hardwired buttons, which are dedicated for specific functions.

The present invention can provide expanded functionality to a user input device having one or more hardwired user input mechanisms (e.g., hardwired buttons) with little increase in cost, complexity, and device size. In particular, the present invention can expand the functionality of user input devices by changing the functions assigned to hardwired user input mechanisms responsive to user actuation of a function-change user input mechanism, responsive to automatic detection of an application change, or a combination thereof. Each hardwired user input mechanism can have an associated dedicated function indicator that visually indicates the function assigned to that mechanism. The present invention also can change the function indicated by the function indicators when there is a change in the functions assigned to their associated hardwired user input mechanisms.

As used herein, a “hardwired user input mechanism” refers to a user input mechanism that can initiate one or more hardwired functions when actuated. The term “dedicated function indicator” refers to a function indicator that is dedicated to providing visual indication of the function assigned to an associated user input mechanism. The term “function-change user input mechanism” refers to a user input mechanism that permits a user to notify the user input device that the user wants to change the functions assigned to hardwired user input mechanism(s) from one set of hardwired functions to another set of hardwired functions. The function-change user input mechanism can be hardwired to a specific user input mechanism or soft-coded to any user input mechanism.

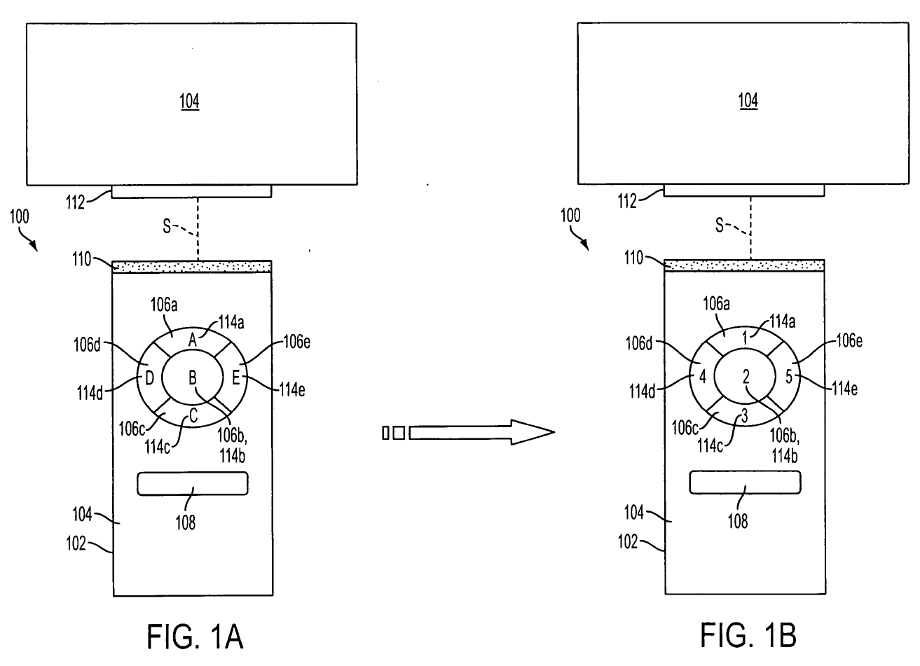

FIGS. 1A-1B show an illustrative user input device in accordance with one embodiment of the present invention. System 100 can include user input device 102 that can transmit signals to remote host device 104. In one embodiment of the present invention, user input device 102 can comprise a remote control for controlling remote host device 104. Remote host device 104 can be any electronic device controllable by a remote control. Examples of system 100 can include television systems, audio systems, digital media receivers similar to Apple TV™ sold by Apple Inc. of Cupertino, Calif., other set-top boxes, other media devices, or any combination thereof.

User interface device 102 can include housing 104, one or more hardwired user input mechanisms 106, function-change user input mechanism 108, and transmitter 110, which can transmit signals S to receiver 112 of remote host device 104. In the embodiment of FIGS. 1A-1B, the user interface device can be equipped with five hardwired user input mechanisms 106a-106e. Each hardwired user input mechanism 106 can have an associated dedicated function indicator 114 disposed on or near the user input mechanism. In the embodiment shown in FIG. 1A, the function indicators indicate that function “A” is assigned to hardwired user input mechanism 106a, function “B” is assigned to hardwired user input mechanism 106b, function “C” is assigned to hardwired user input mechanism 106c, function “D” is assigned to hardwired user input mechanism 106d, and function “E” is assigned to hardwired user input mechanism 106e.

In accordance with one embodiment of the present invention, user input device 102 can change the function assigned to one or more of hardwired user input mechanisms 106 responsive to a function-change signal from function-change user input mechanism 108. For example, function-change user input mechanism 108 can be a switch that can identify a user's gesture of sliding left-to-right or right-to-left. When the switch is moved from one position to the other, function-change user input mechanism 108 can generate a function-change signal. User input device 102 can change the functions assigned to hardwired user input mechanisms 106 responsive to that signal. For example, in response to a function-change signal from function-change user input mechanism 108, device 102 can change the function assigned to hardwired user input mechanism 106a from function “A” to function “1”, the function assigned to hardwired user input mechanism 106b from function “B” to function “2”, the function assigned to hardwired user input mechanism 106c from function “C” to function “3”, the function assigned to hardwired user input mechanism 106d from function “D” to function “4”, and the function assigned to hardwired user input mechanism 106e from function “E” to function “5”. Device 102 also can change the functions indicated by dedicated function indicators 114a-114e accordingly.

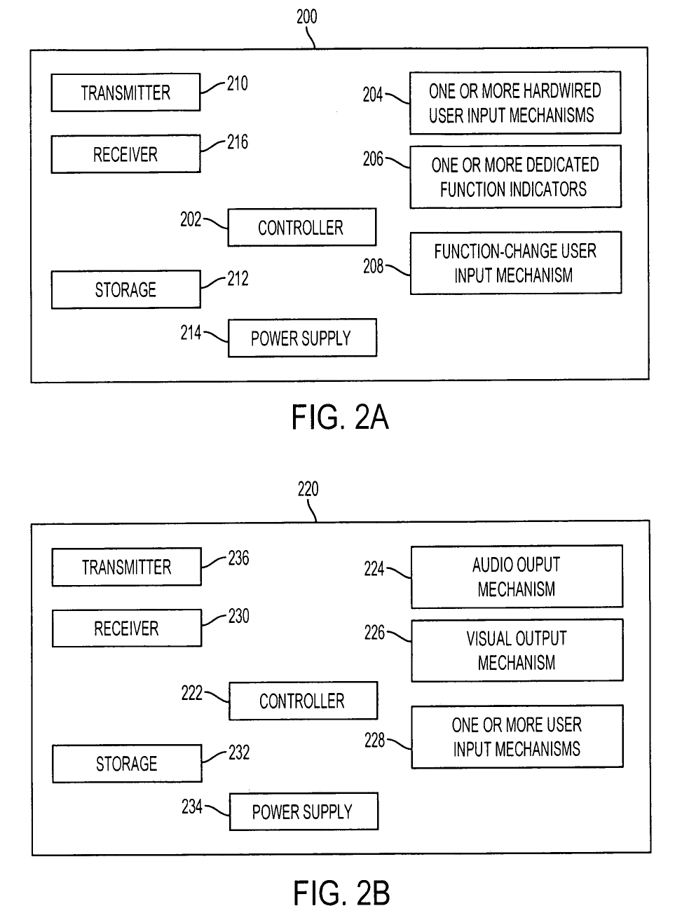

FIG. 2A is an illustrative block diagram of the user input device of FIG. 1 in accordance with one embodiment of the present invention. User input device 200 can have controller 202, one or more hardwired user input mechanisms 204, one or more dedicated function indicators 206 (each one associated with one of the hardwired user input mechanisms), function-change user input mechanism 208, transmitter 210, storage 212, and power supply 214. Device 200 also can include additional features that are not shown to simplify the drawing.

Controller 202 may be operative to perform some or all of the operations implemented on device 200. Any suitable number or type of operations may be implemented. Software, firmware, or any other type of code used by controller 202 can be partially or wholly stored on the device (e.g., in storage 212) and/or on a remote server. The code can be partially or wholly run by controller 202 and/or a controller of a remote server.

Hardwired user input mechanisms 204 can be any suitable mechanism for providing user inputs to device 200. More particularly, each hardwired user input mechanism 204 can initiate one or more functions hardwired to the mechanism when it is user actuated. Mechanisms 204 can take a variety of forms, such as one or more: buttons, keypads, dials, trackballs, sliders, clickwheels/scrollwheels, inertial sensors (e.g., accelerometers, motion sensors, gyroscopes, etc.), non-inertial motion sensors, or any combination thereof. Hardwired user input mechanisms 20 also can be any other appropriate design known in the art or otherwise.

Each function indicator 206 can visually indicate the function assigned to an associated hardwired user input mechanism, and can be disposed on or near the associated user input mechanism. Each function indicator can be, for example, a backlit LED mask, an LCD, or any other icon, text, or graphic display. In one embodiment of the present invention, device 200 can change the function indicated by a function indicator responsive to a signal indicative of a user's desire to change the functions assigned to hardwired user input mechanisms 204 and/or responsive to an application change (as discussed in more detail below).

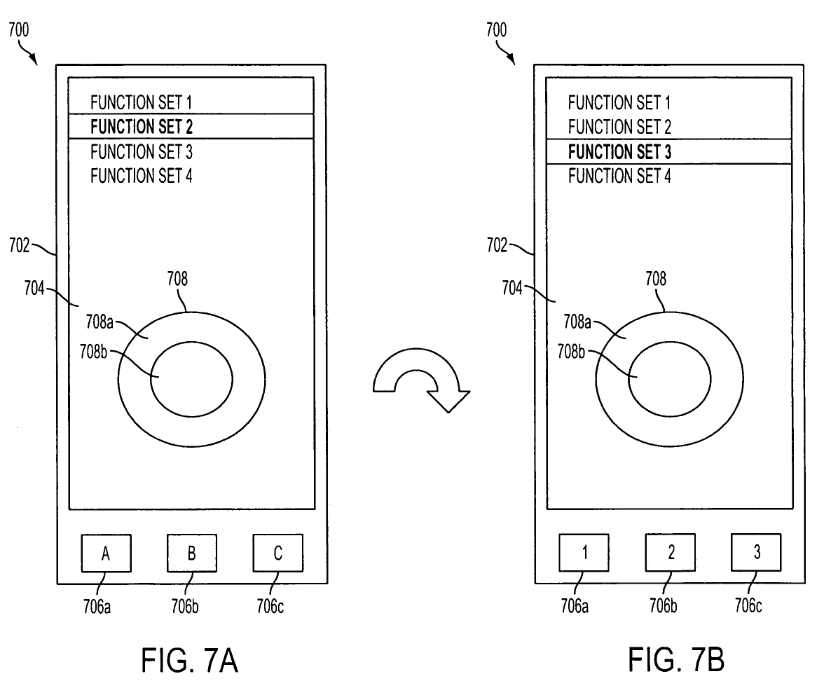

Function-change user input mechanism can be, for example, one or more: one-dimensional switches, multi-dimensional switches, buttons, inertial sensors (e.g., accelerometers, motion sensors, gyroscopes, etc.), non-inertial motion sensors, microphones, or any combination thereof. A one-dimensional switch can be a switch that can sense a user's gesture in one dimension. A multi-dimensional switch can be a switch that can sense a user's gesture in multiple dimensions (see, e.g., FIGS. 7A-7B). Examples of switches can include mechanical switches, force sensor arrays, capacitive or resistive touch sensors, or any other switch design. Function-change user-input mechanism also can be any other appropriate design known in the art or otherwise.

Transmitter 210 can be configured to transmit signals from user input device 200 to a remote host device (e.g., remote host device 112 of FIGS. 1A-1B). Transmitter 210 can employ a wired protocol, a wireless protocol, or any combination thereof. In one embodiment of the present invention, transmitter 210 can be configured to transmit infrared signals to the remote host device.

Storage 212 can store firmware (e.g., an operating system, user interface functions, and processor functions) and information related to other devices with which device 200 communicates (e.g., a remote host device). Storage 212 can include, for example, cache, Flash, ROM, and/or RAM. Storage 212 can include local and/or remote storage. For example, storage 212 can include both local ROM, RAM, and cache, and storage space on a remote server.

In one embodiment of the present invention, storage 212 can have a database in which is stored information regarding the function sets that can be assigned to the hardwired user input mechanisms. For example, the database can store associations of functions to hardwired user input mechanisms and to function indicators. Thus, when a device of the present invention determines that it needs to change the functions assigned to the hardwired user input mechanisms and indicated by the function indicators, the device can obtain the necessary information from storage 212.

Power supply 214 can provide power to user input device 200. Supply 214 can include, for example, one or more batteries and a battery charger input. Alternatively, power can be supplied through a dedicated or non-dedicated cable.

FIG. 2B is an illustrative block diagram of a remote host device configured to interact with the user input device of FIGS. 1A-1B in accordance with one embodiment of the present invention. Remote host device 220 can have controller 222, audio output mechanism 224, visual output mechanism 226, one or more user input mechanisms 228, receiver 230, storage 232, and power supply 234. Any one of these components can be similar to a like-named component described above with respect to FIG. 2A. Device 220 also can include additional features that are not shown to simplify the drawing.

Receiver 230 can be configured to accept signals transmitted from user input device 200 and route the signals or a processed version of the signals to controller 222 or another component in remote host device 220. For example, if the signals are routed to controller 222, the controller can use the signals to control some operational aspect of remote host device 220. For example, the signals can instruct the controller to adjust volume, select an option presented to a user via visual output mechanism 226, change an image shown on visual output mechanism 226, change an audio file being played back through audio output mechanism 224, etc.

Receiver 230 can be configured to complement transmitter 210. Receiver 230 can employ a wired protocol, a wireless protocol, or any combination thereof, depending on the protocol employed by transmitter 210. For example, if transmitter 210 is configured to transmit infrared signals, receiver 230 can be configured to receive infrared signals.

Controller 222 may be operative to perform some or all of the operations implemented on device 220. Software, firmware, or any other type of code used by controller 222 can be partially or wholly stored on the device (e.g., in storage 232) and/or on a remote server.

Audio output mechanism 224 can include any suitable audio component for providing audio to a user. For example, audio output mechanism 224 can include one or more speakers (e.g., mono or stereo speakers) built into device 220 or coupled to device 220 wirelessly or through a wired connection.

Visual output mechanism 226 can include any suitable component for providing visual data to a user. In some embodiments of the present invention, visual output mechanism 226 can include one or more television displays or one or more computer monitors.

User input mechanism(s) 228 can include any suitable component for accepting input from users. Examples of user input mechanisms can take a variety of forms, such as one or more: buttons, keypads, dials, trackballs, sliders, clickwheels/scrollwheels, touch screens, microphones, inertial sensors (e.g., accelerometers, motion sensors, gyroscopes, etc.), non-inertial motion sensors, or any combination thereof.

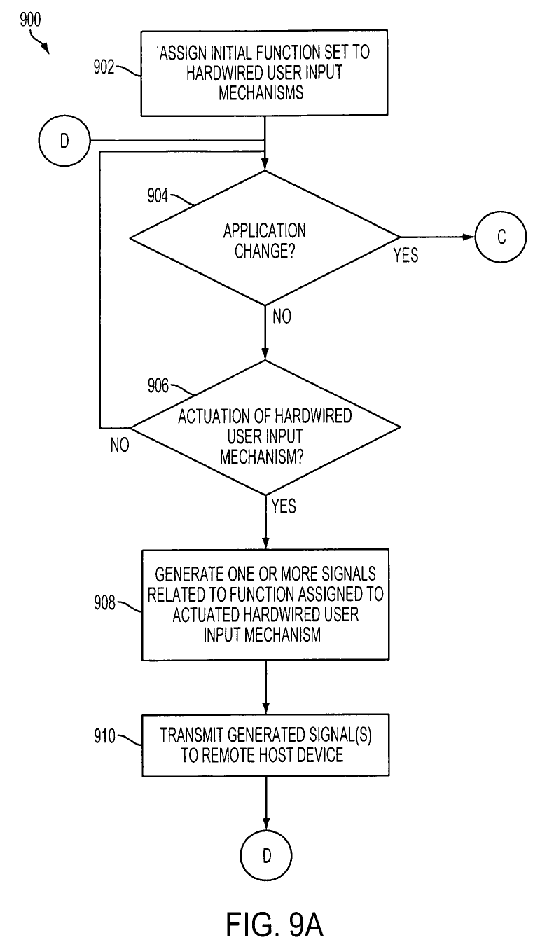

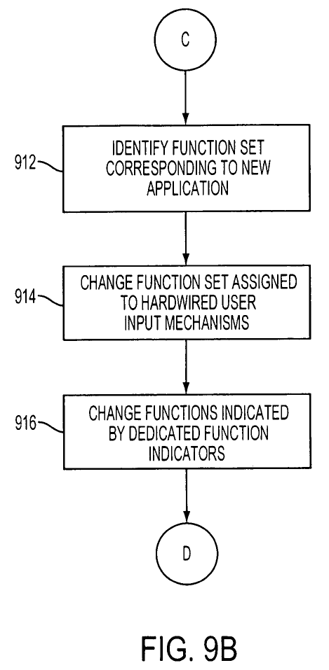

In one embodiment of the present invention discussed in greater detail with respect to FIGS. 9A-9B, user input device 200 can be configured to change the functions assigned to the hardwired user input mechanisms responsive to an automatic detection of an application change. For example, user input device 200 can be configured to control one or more applications running on remote host device 220. When the application running on the remote host device changes, the remote host device can send a signal to the user input device. When the user input device receives the signal, the user input device can detect the application change and, responsive thereto, change the functions assigned to the hardwired user input mechanisms.

To facilitate this process, remote host device 220 can include transmitter 236 and user input device 200 can include receiver 216. In one embodiment of the present invention, transmitter 236 can be similar to transmitter 210 and receiver 216 can be similar to receiver 230.

In other embodiments of the present invention, the user input device can automatically detect an application change without receiving a signal from another device. For example, the controller of the user input device can detect the application change based on its own internal processing, particularly when the controller in the user input device is running the application(s).

As used herein, an application change can include a change from one application to another application or a change in operating modes within a single application. Applications can include software, firmware, or any other body of code.

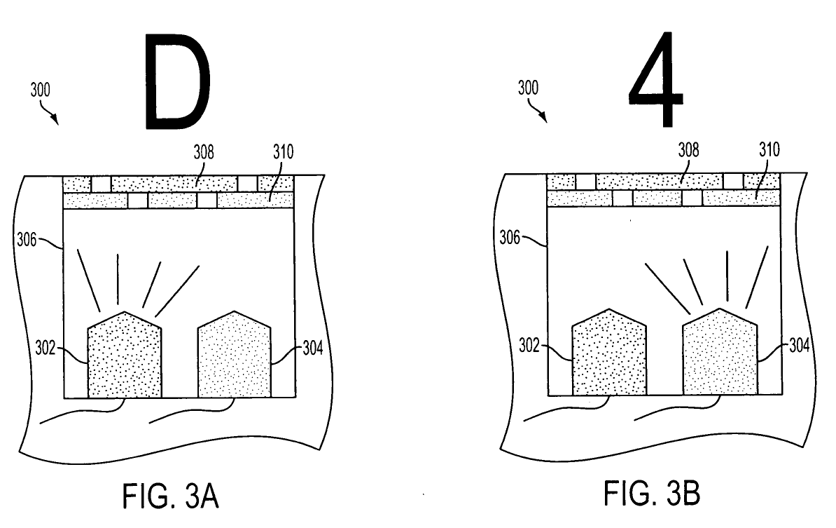

FIGS. 3A-3B show a first illustrative function indicator in accordance with one embodiment of the present invention. Function indicator 300 can be configured to visually indicate one or more functions. In the example of FIGS. 3A-3B, function indicator is configured to visually indicate at least two functions: function “D” and “4”. So, when the associated hardwired user input mechanism is assigned with function “D”, function indicator 300 can display “D” to the user. When the user input device changes the assigned function from “D” to “4”, function indicator 300 can display “4” to the user.

Function indicator 300 can include multiple light sources (e.g., light sources 302 and 304), light director 306, multiple masks (e.g., masks 308 and 310), and wires or other conductive mechanisms (e.g., traces in a circuit board) to electrically couple light sources 302 and 304 to a controller and/or power supply. The masks selectively transmit light from the light sources so that the proper function is indicated by the function indicator.

Light sources 302 and 304 can be, for example, LEDs that each emit a different wavelength of light. Each wavelength or combinations of wavelengths can be used to signify different information. Controller 202 can be operable to activate each light source individually or in combination.

The purpose of light director 306 can be to direct light from the light sources to masks 308 and 310. Light director 306 can, for example, be made of an opaque material such that light from the light sources cannot pass through. In some embodiments of the present invention, light director 306 also can be constructed to diffuse light from the light sources to conceal whether the light is being generated by light source 302 or light source 304. One embodiment of a light diffuser is described in greater detail in U.S. patent application Ser. No. 11/824,453, filed on Jun. 28, 2007, entitled “Light Diffuser,” the entirety of which is incorporated herein by reference.

Masks 308 and 310 can be used to ensure that light exits from function indicator 300 in predetermined patterns (e.g., text, image, or a combination thereof). Each mask can have areas that are opaque to a certain wavelength of light (e.g., one of the wavelengths emitted by light sources 302 and 304) and non-opaque areas that permit that same wavelength to be transmitted. The areas that permit transmission can have a pattern that displays a text or image that represents a function. As used herein, an area on a mask is opaque to a predetermined wavelength or wavelengths of light. Mask opacity does not necessarily prevent all wavelengths of light from passing through.

For example, mask 308 can be made of a material having opaque areas that only prevents light emitted from light source 302 from passing through, while mask 310 can be made of a material having opaque areas that only prevents light emitted from light source 304 from passing through. Thus, when light source 302 emits light, that light can pass through mask 310 and the non-opaque areas of mask 308. If the non-opaque areas of mask 308 form a pattern that represents function “D”, function indicator 300 can display “D” when light source 302 emits light. See, e.g., FIG. 3A. Likewise, when light source 304 emits light, that light can pass through non-opaque areas of mask 310 and any area of mask 308. If the non-opaque areas of mask 310 form a pattern that represents function “4”, function indicator 300 can display “4” when light source 304 emits light. See, e.g., FIG. 3B.

If function indicator 300 needs to indicate a third function, a third mask can be added in accordance with the teachings of the present invention. The third mask can be made of a material having opaque areas that only prevent light having a third wavelength from passing through. The third wavelength of light can be generated, for example, by a third light source or a combination of the light emitted by light sources 302 and 304.

In an alternative embodiment of the present invention, mask 308 can be made of a material that permits light emitted only from light source 302 to be transmitted, while mask 310 can be made of a material that permits light emitted from light source 304 to be transmitted. In order to display a desired text or image, the opaque and non-opaque areas of the masks may need to be arranged.

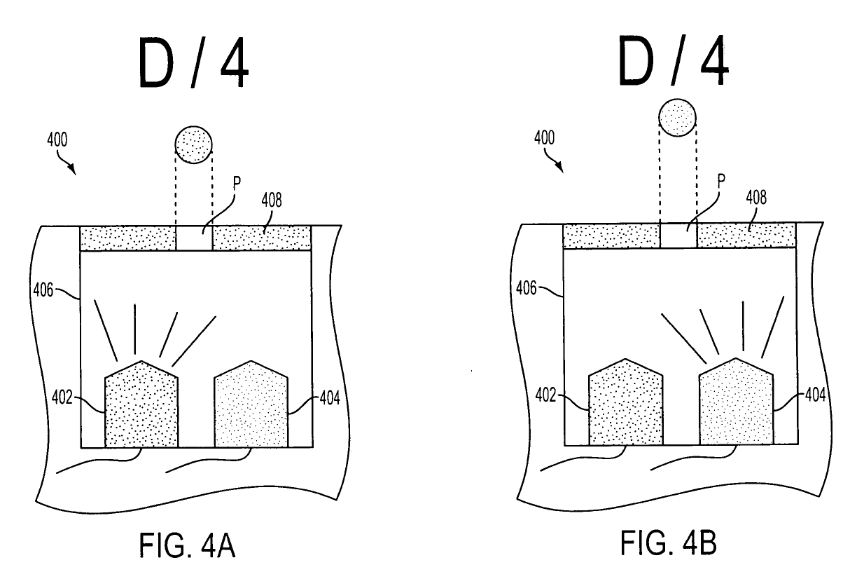

FIGS. 4A-4B show a second illustrative function indicator in accordance with an embodiment of the present invention. Function indicator 400 can be configured to visually indicate two or more functions. Function indicator 400 can include multiple light sources (e.g.; light sources 402 and 404), light director 406, mask 408, and wires or other conductive mechanisms (e.g., traces in a circuit board) to electrically couple light sources 402 and 404 to a controller and/or power supply. Mask 408 can be made of a material that prevents light from light sources 402 and 404 to be transmitted through opaque areas and light from light source 402 and light source 404 to be transmitted through non-opaque areas (either individually or in combination).

In the example of FIGS. 4A-4B, function indicator 400 is configured to visually indicate two functions: function “D” and “4”. When the associated hardwired user input mechanism is assigned with function “D”, light source 402 can project light of a first predetermined color through one or more perforations (or micro-perforations) P. See, e.g., FIG. 4A. When the user input device changes the assigned function from “D” to “4”, light source 404 can project light of a second predetermined color through P. See, e.g., FIG. 4B. If function indicator 400 needs to indicate a third function, a third light source can be provided or the light from both light sources 402 and 404 can be combined.

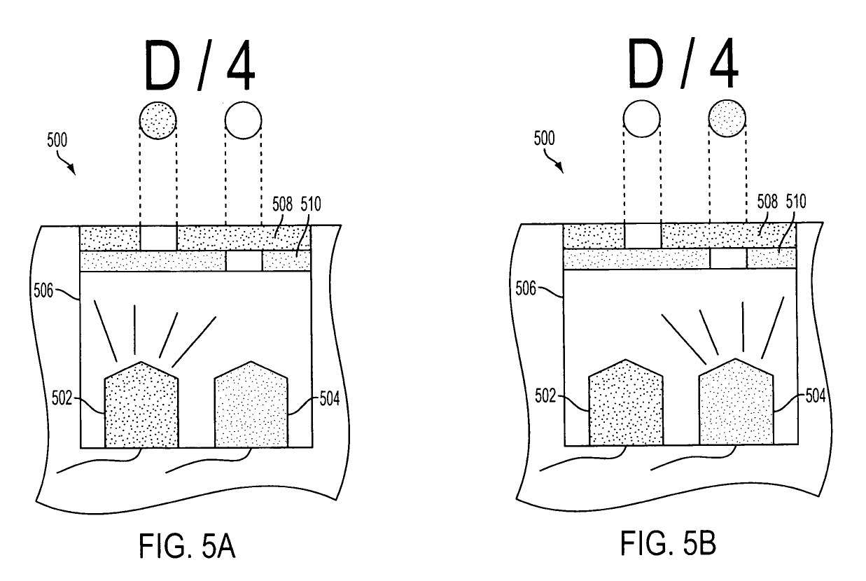

FIGS. 5A-5B show a third illustrative function indicator in accordance with an embodiment of the present invention. Like function indicator 300 of FIGS. 3A-3B, function indicator 500 also can have multiple light sources (e.g., light sources 502 and 504), light director 506, multiple masks (e.g., masks 508 and 510), and wires or other conductive mechanisms (e.g., traces in a circuit board) to electrically couple light sources 502 and 504 to a controller and/or power supply. Again, similar to masks 308 and 310, each mask of function indicator 500 can have areas that are opaque to a certain wavelength of light (e.g., one of the wavelengths emitted by light sources 502 and 504) and non-opaque areas that permit that same wavelength to be transmitted.

In contrast to masks 308 and 310, however, the areas that permit transmission in masks 508 and 510 can be of a generic shape disposed in close proximity to a marking (e.g., text, image, or combination thereof) that represents the assignable functions. For example, when light source 502 emits light, that light can pass through mask 510 and the non-opaque area(s) of mask 508 (e.g., a round shape). Those non-opaque area(s) can be disposed in close proximity to a marking that represents function “D”. See, e.g., FIG. 5A. Likewise, when light source 504 emits light, that light can pass through non-opaque area(s) of mask 510 and any area of mask 508 (e.g., a round shape). Those non-opaque area(s) of mask 510 can be disposed in close proximity to a marking that represents function “4”. See, e.g., FIG. 3B.

If function indicator 500 needs to indicate a third function, a third mask can be added in accordance with the teachings of the present invention. The third mask can be made of a material having opaque areas that only prevent light having a third wavelength from passing through. The third wavelength of light can be generated, for example, by a third light source or a combination of the light emitted by light sources 502 and 504.

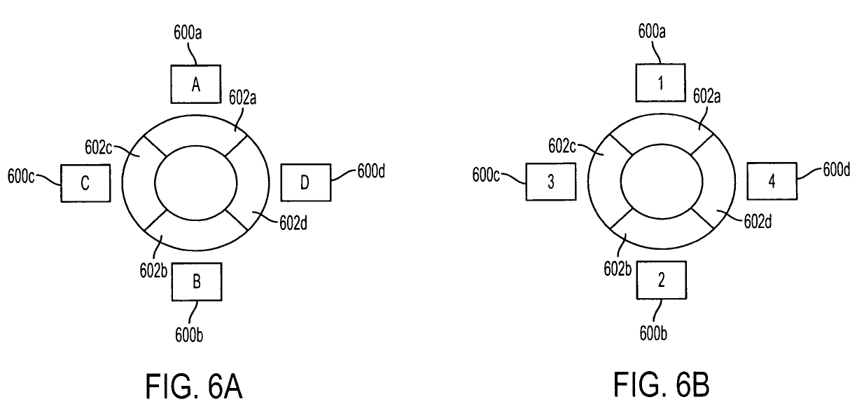

FIGS. 6A-6B show a fourth illustrative function indicator in accordance with an embodiment of the present invention. Function indicators 600a-600d can include, for example, liquid crystal displays, each of which can be disposed in close proximity to the hardwired user input mechanism to which it is associated. For example, function indicators 600a-600d can be associated with hardwired user input mechanisms 602a-602d, respectively. Thus, when a user input device of the present invention has assigned functions “A,” “B,” “C,” and “D” to hardwired user input mechanisms 602a-602d (respectively), function indicators 600a-600d can respectively display text or images representing those functions. When the user input device changes the functions assigned to hardwired user input mechanisms 602a-602d to functions “1,” “2,” “3,” and “4,” function indicators 600a-600d can change the text or image displayed to correspond to those newly assigned functions.

FIGS. 7A-7B show another illustrative user input device in accordance with one embodiment of the present invention. User input device 700 can include housing 702, touch-sensitive display 704, and hardwired user input mechanisms 706a-706c. Touch-sensitive display 704 can include a touchscreen display or a multi-touch interface (e.g., similar to that incorporated into an iPhone™ sold by Apple Inc.).

In contrast to user input device 100, which can have a hardwired function-change user input mechanism, user input device 700 can have soft-coded function-change user input mechanism 708. Soft-coded function-change user input mechanism 708 can accept user input via touch-sensitive display 704. In one embodiment, soft-coded function-change user input mechanism 708 can emulate a user input mechanism similar to the clickwheel/scrollwheel provided on some models of iPods™ sold by Apple Inc. Function-change user input mechanism 708 can have two regions of input: scroll region 708a and button region 708b. When scroll region 708a is actuated, it can cause device 700 to scroll through selections displayed on touch-sensitive display 704. When button region 708b is actuated, it can cause device 700 to accept a selection identified on touch-sensitive display 704.

In one embodiment of the present invention, a person can use soft-coded user input mechanism 708 to identify and select a function set to assign to hardwired user input mechanisms 706a-706c. For example, as shown in FIG. 7A, hardwired user input mechanisms 706a-706c initially can be assigned functions “A,” “B,” and “C.” To change the functions, the user may run his finger around scroll region 708a until the desired function set is highlighted on display 704 (e.g., “Function set 3” as shown in FIG. 7B). Then, the user may tap button region 708b to select the highlighted function set. Thereafter, the functions associated with the selected function set (e.g., functions “1,” “2,” and “3”) can be assigned to hardwired user input mechanism 706a-706c, respectively. See, e.g., FIG. 7B.

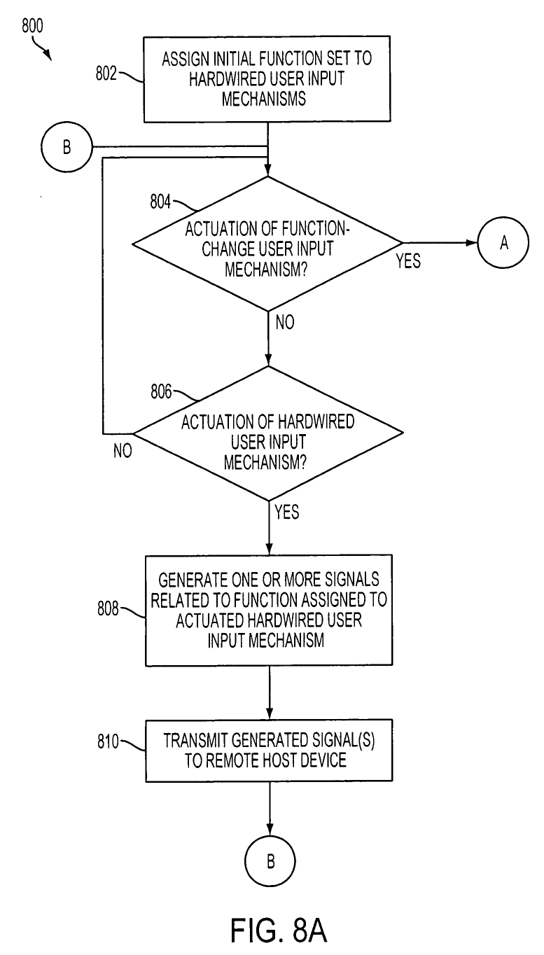

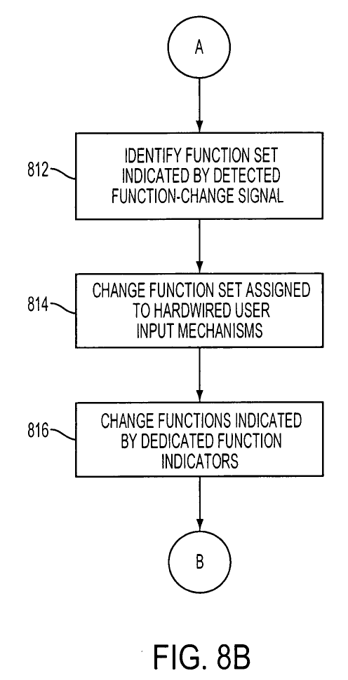

FIGS. 8A-8B is an illustrative flowchart of a user-initiated process for changing the functions assigned to hardwired user input mechanisms in accordance with one embodiment of the present invention. Process 800 can begin at step 802, during which a user input device can assign an initial function set to the hardwired user input mechanisms. At step 804, the device can determine whether the user has actuated the function-change user input mechanism.

If not, the device then can determine whether the user has actuated one of the hardwired user input mechanisms. Responsive to a positive determination in step 806, the device can generate one or more signals related to the function assigned to the actuated hardwired user input mechanism at step 808. In step 810, the device can transmit the signal(s) generated in step 808 to a remote host device in one embodiment of the present invention in which the user input device is a remote control. However, if the user input device is not configured to control a remote host device, the signal(s) generated in step 808 can be transmitted internally to the appropriate electronic component. If the device determines that the user did not actuate any of the hardwired user input mechanisms in step 806, the device can then return to step 804.

If the device detects that the user has actuated the function-change user input mechanism in step 804, the device then can proceed to step 812. In step 812, the device can identify the function set corresponding to the function-change signal detected in step 804. Thereafter, in step 814, the device can change the function set assigned to the hardwired user input mechanisms. That is, the device can change the functions assigned to each hardwired user input mechanism that permits multiple functions to be assigned thereto. In step 816, responsive to the function-change signal detected in step 804, the device also can change the functions indicated by the dedicated function indicators.

FIGS. 9A-9B is an illustrative flowchart of an automatic process for changing the functions assigned to hardwired user input mechanisms in accordance with one embodiment of the present invention. In contrast to process 800, process 900 can automatically detect the need to change the function set assigned to the hardwired user input mechanisms, rather than relying on user input from a function-change user input mechanism. A user input device employing process 900 can change the functions assigned to the hardwired user input mechanisms responsive to an automatic detection of an application change.

Process 800 can begin at step 802. In step 802, a user input device can assign an initial function set to the hardwired user input mechanisms having changeable functions assignable thereto.

In step 904 (which replaces step 804 of process 800), the device can determine whether there has been an application change. For example, the user input device can be configured to control one or more applications running on a remote host device. When the application running on the remote host device changes, the remote host device can send a signal to the user input device (e.g., via transmitter 236 and receiver 216 of FIGS. 2A-2B). When the user input device receives the signal, the user input device can detect the application change (step 904). Responsive thereto, the device can identify the function set corresponding to the new application (step 912) and change the functions assigned to the hardwired user input mechanisms (step 914).

In other embodiments of the present invention, the user input device can automatically detect an application change without receiving a signal from another device. For example, the controller of the user input device can detect the application change based on its own internal processing, particularly when the user input device is running the application(s).

Thereafter, in step 916, the device can change the functions indicated by the dedicated function indicators responsive to the application change detected in step 904.

If the device determines that there is not an application change in step 904, the device then can determine whether the user has actuated one of the hardwired user input mechanisms in step 906. Responsive to a positive determination in step 906, the device can generate one or more signals related to the function assigned to the actuated hardwired user input mechanism at step 908. In step 910, the device can transmit the signal(s) generated in step 908 to a remote host device in an embodiment of the present invention in which the user input device is a remote control. However, if the user input device is not configured to control a remote host device, the signal(s) generated in step 908 can be transmitted internally to the appropriate electronic component. If the device determines that the user did not actuate any of the hardwired user input mechanisms in step 906, the device can then return to step 904.

Although particular embodiments of the present invention have been described above in detail, it will be understood that this description is merely for purposes of illustration. Alternative embodiments of those described hereinabove also are within the scope of the present invention. For example, it is within the scope of the present invention for a user input device to have one or more hardwired user input mechanisms that cannot change functions, along with one or more hardwired user input mechanisms that can. Also, FIGS. 8A-9B only present illustrative flowcharts in accordance with some embodiments of the present invention. One or more of the steps described with respect to those figures can be removed, consolidated, or reordered without departing from the present invention.

Combinations of the above-described illustrative embodiments also are within the scope of the present invention. For example, while FIGS. 8A-8B and 9A-9B describe separate processes for expanding the functionality of a user input device, those processes can be combined in a user input device of the present invention to change the function assigned to one or more hardwired user input mechanisms responsive to user actuation of a function-change user input mechanism and responsive to automatic detection of an application change.

The above described embodiments of the present invention are presented for purposes of illustration and not of limitation, and the present invention is limited only by the claims which follow.

What is claimed is:

1. A user input device comprising:
at least a first hardwired user input mechanism, wherein a plurality of functions are assignable thereto;
at least a first dedicated function indicator for indicating the function assigned to the first hardwired user input mechanism;
a function-change user input mechanism that transmits a function-change signal when user actuated; and
a controller configured to:
change the function assigned to the first hardwired user input mechanism responsive to the function-change signal;
change the function indicated by the first dedicated function indicator responsive to the function-change signal; and
generate one or more signals related to the function assigned to the first hardwired user input mechanism responsive to actuation thereof.

2. The user input device of claim 1, wherein the user input device comprises a remote control.

3. The user input device of claim 1, wherein the function-change user input mechanism comprises a one-dimensional switch or a multi-dimensional switch.

4. The user input device of claim 1, wherein the function-change user input mechanism comprises one or more inertial sensors.

5. The user input device of claim 1, wherein the function-change user input mechanism comprises one or more motion sensors.

6. The user input device of claim 1, wherein the first dedicated function indicator comprises multiple light sources and multiple masks, wherein the multiple masks selectively transmit light from the multiple light sources.

7. The user input device of claim 6, wherein the first dedicated function indicator further comprises a light diffuser that diffuses light from the multiple light sources.

8. The user input device of claim 6, wherein the multiple masks selectively transmit light in predetermined patterns that form text, an image, or a combination thereof.

9. The user input device of claim 1, wherein the first dedicated function indicator is disposed in close proximity to a marking that represents one or more functions.

10. The user input device of claim 1, wherein the first dedicated function indicator comprises a liquid crystal display.

11. The user input device of claim 1, wherein the controller further is configured to:
automatically detect an application change;
change the function assigned to the first hardwired user input mechanism responsive to the detected application change; and
change the function indicated by the first dedicated function indicator responsive to the detected application change.

12. A user input device comprising:
at least a first hardwired user input mechanism, wherein a plurality of functions are assignable thereto;
at least a first dedicated function indicator for indicating the function assigned to the first hardwired user input mechanism; and
a controller configured to:
automatically detect an application change;
change the function assigned to the first hardwired user input mechanism responsive to the detected application change;
change the function indicated by the first dedicated function indicator responsive to the detected application change; and
generate one or more signals related to the function assigned to the first hardwired user input mechanism responsive to actuation thereof.

13. The user input device of claim 12, wherein the user input device comprises a remote control.

14. The user input device of claim 12, wherein the application change comprises a change from one application to another application.

15. The user input device of claim 12, wherein the application change comprises a change in operating modes within a single application.

16. The user input device of claim 12, further comprising a receiver, wherein the controller is configured to detect the application change based on a signal transmitted from a remote host device to the receiver.

17. The user input device of claim 12, further comprising a function-change user input mechanism that transmits a function-change signal when user actuated, wherein the controller further is configured to:
change the function assigned to the first hardwired user input mechanism responsive to the function-change signal; and
change the function indicated by the first dedicated function indicator responsive to the function-change signal.

18. A method for expanding the functionality of a user input device, the method comprising:
detecting a function-change signal from a function-change user input mechanism;
changing the function assigned to a first hardwired user input mechanism responsive to the function-change signal;
changing the function indicated by a first dedicated function indicator responsive to the function-change signal, wherein the first dedicated function indicator indicates the function assigned to the first hardwired user input mechanism; and
generating one or more signals related to the function assigned to a first hardwired user input mechanism responsive to actuation thereof.

19. The method of claim 18, wherein detecting a function-change signal from a function-change user input mechanism comprises detecting a function-change signal from a one-dimensional switch.

20. The method of claim 18, wherein detecting a function-change signal from a function-change user input mechanism comprises detecting a function-change signal from a multi-dimensional switch.

21. The method of claim 18, further comprising selectively transmitting light from the first dedicated function indicator, wherein the light is selectively transmitted through multiple masks.

22. The method of claim 21, wherein selectively transmitting light comprises selectively transmitting light in predetermined patterns that form text, an image, or a combination thereof.

23. A method for expanding the functionality of a user input device, the method comprising:
automatically detecting an application change;
changing the function assigned to a first hardwired user input mechanism responsive to the detected application change;
changing the function indicated by a first dedicated function indicator responsive to the detected application change, wherein the first dedicated function indicator indicates the function assigned to the first hardwired user input mechanism; and
generating one or more signals related to the function assigned to a first hardwired user input mechanism responsive to actuation thereof.

24. The method of claim 23, wherein automatically detecting an application change comprises automatically detecting a change from one application to another application.

25. The method of claim 23, wherein automatically detecting an application change comprises automatically detecting a change in operating modes within a single application.

26. The method of claim 23, wherein automatically detecting an application change comprises detecting the application change based on a signal transmitted from a remote host device.
